(19) United States
(12) Patent Application Publication
(10) Pub. No.: US 2012/0287333 A1
(43) Pub. Date: Nov. 15, 2012

(54) DOUBLE DIRECTION CAMERA AND PORTABLE ELECTRONIC DEVICE

(75) Inventors: Chien-Chiang HUANG, Kuei Shan Hsiang (TW); Jen-Ho CHANG, Kuei Shan Hsiang (TW); Wei-Chung HUANG, Kuei Shan Hsiang (TW)

(73) Assignee: QUANTA COMPUTER INC., Kuei Shan Hsiang (TW)

(21) Appl. No.: 13/458,490

(22) Filed: Apr. 27, 2012

(30) Foreign Application Priority Data
May 13, 2011 (TW) 100116811

(51) Int. Cl. H04N 5/238

(52) U.S. Cl. 348/369; 348/E05.04

(57) ABSTRACT

A double direction camera is provided, which includes a light sensor, a light path conversion member, a first lens assembly and a second lens assembly. The light path conversion member is used for converting a direction of a light beam to the light sensor. The first lens assembly is disposed at a first side of the double direction camera and used for receiving the light beam and projecting the light beam to the light path conversion member. The second lens assembly is disposed at a second side of the double direction camera and used for receiving the light beam and projecting the light beam to the light path conversion member.

### CROSS REFERENCE TO RELATED APPLICATIONS

This Application claims priority of Taiwan Patent Application No. 100116811, filed on May, 13, 2011, the entirety of which is incorporated by reference herein.

### BACKGROUND OF THE INVENTION

1. Field of the Invention

The present invention relates to a camera, and in particular relates to a double direction camera which includes two lens assemblies.

2. Description of the Related Art

Please refer to FIG. 1. The conventional camera 10 includes a lens assembly 11, a lens holder 12, a circular board 13 and a light sensor 14. The lens assembly 11 and the circular board 13 are connected to the lens holder 12, and the light sensor 14 is disposed inside the lens holder 12, wherein the light sensor 14 is electrically coupled to the circular board 13.

When the camera 10 takes a photograph, a focused image is projected on the light sensor 14 via a plurality of lenses of the lens assembly 11. The light sensor 14 converts the focused image into digital signals with different strengths, and the digital signals are transferred to back-end elements for processing operations such as image display, image processing or image storage processing operations.

In recent years, most portable electronic devices (portable computers, tablets or portable communicating devices) have been equipped with a camera 10 to take photographs. To meet different demands, some electronic devices are equipped with two cameras 10, wherein the two cameras 10 are respectively disposed at front and back surfaces of the electronic device. However, the manufacturing cost of the camera 10 is so high that the price of the electronic device equipped with two cameras 10 is increased. Additionally, other adjustments and modifications for back-end elements needed for image display and image storage is necessary, which complicates the manufacturing process.

Therefore, a need exists for a camera with a single light sensor which effectuates the same imaging result produced by two cameras.

### BRIEF SUMMARY OF THE INVENTION

In order to reduce manufacturing cost of the double direction camera and simplify the manufacturing process thereof, the invention provides a double direction camera, wherein a single camera is used for capturing images from different directions.

One of the objectives of the invention is to provide a double direction camera, which has a first side and a second side opposite to the first side and includes a light sensor, a light path conversion member, a first lens assembly and a second lens assembly. The light path conversion member is used for converting a direction of a light beam to the light sensor. The first lens assembly, disposed on the first side, is used for receiving the light beam and projecting the light beam to the light path conversion member. The second lens assembly, disposed on the second side, is used for receiving the light beam and projecting the light beam to the light path conversion member. The light beam passing through the first lens assembly is refracted by the first prism and projected to the light sensor, and the light beam passing through the second lens assembly is refracted by the second prism and projected to the reflective mirror and reflected to the light sensor by the reflective mirror.

The travelling distance of the first light beam from the first lens assembly to the light sensor is different from the travelling distance of the second light beam from the second lens assembly to the light sensor. In this regard, two solutions are provided in the invention.

If both of the first and second lens assemblies have the same focal length, a distance between the first lens assembly and the light path conversion member is larger than a distance between the second lens assembly and the light path conversion member. If the focal length of the second lens assembly is larger than the first lens assembly, a distance between the first lens assembly and the light path conversion member may equal to a distance between the second lens assembly and the light path conversion member.

In the other embodiment, the light path conversion member includes two lateral mirrors, respectively facing the first lens assembly and the second lens assembly.

In the other embodiments, the light path conversion member includes a prism and the two sides of the prism respectively face the first lens assembly and the second lens assembly.

It is noted that the first lens assembly, the second lens assembly and the light path conversion member are disposed along the same straight line.

By the light path conversion member, light beams from different direction are guided to the same light sensor. Hence, the problem exist in the prior art is solved.

Yet another objective of the invention is to provide a portable electronic device, which includes a housing, a light sensor, a light path conversion member, a first lens assembly and a second lens assembly. The housing has a front side and a back side opposite to the front side and includes a first opening, a second opening and two protective covers. The first opening is formed at the front side, and the second opening is formed at the back side. Two protective covers respectively correspond to the first opening and the second opening.

The first lens assembly, disposed at the first side, is used for receiving the light beam and projecting the light beam to the light path conversion member. The second lens assembly, disposed at the second side, is used for receiving the light beam and projecting the light beam to the light path conversion member.

### BRIEF DESCRIPTION OF THE DRAWINGS

The present invention is more fully understood by reading the subsequent detailed description and examples with references made to the accompanying drawings, wherein:

FIG. 1 is a schematic view of a conventional camera;

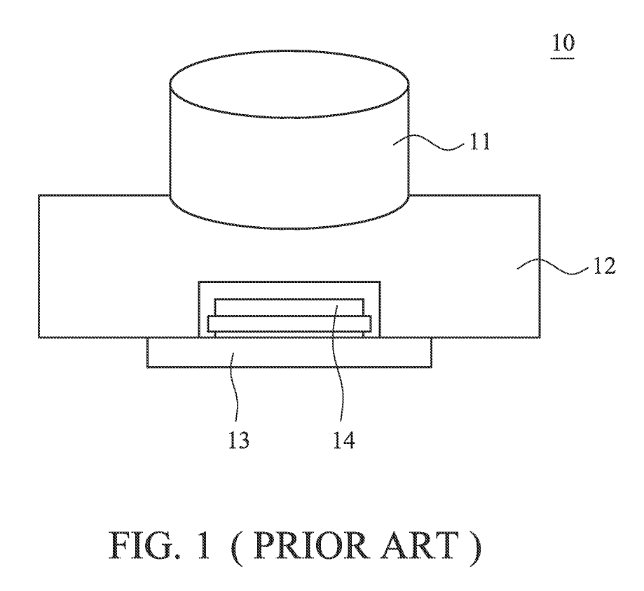

FIG. 2 is a schematic view of a double direction camera of a first embodiment of the invention;

FIG. 3 is a schematic view of a double direction camera of a second embodiment of the invention;

FIG. 4 is a schematic view of a double direction camera of a third embodiment of the invention; and

FIG. 5 is a schematic view of the camera of the invention applied in a portable electronic device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

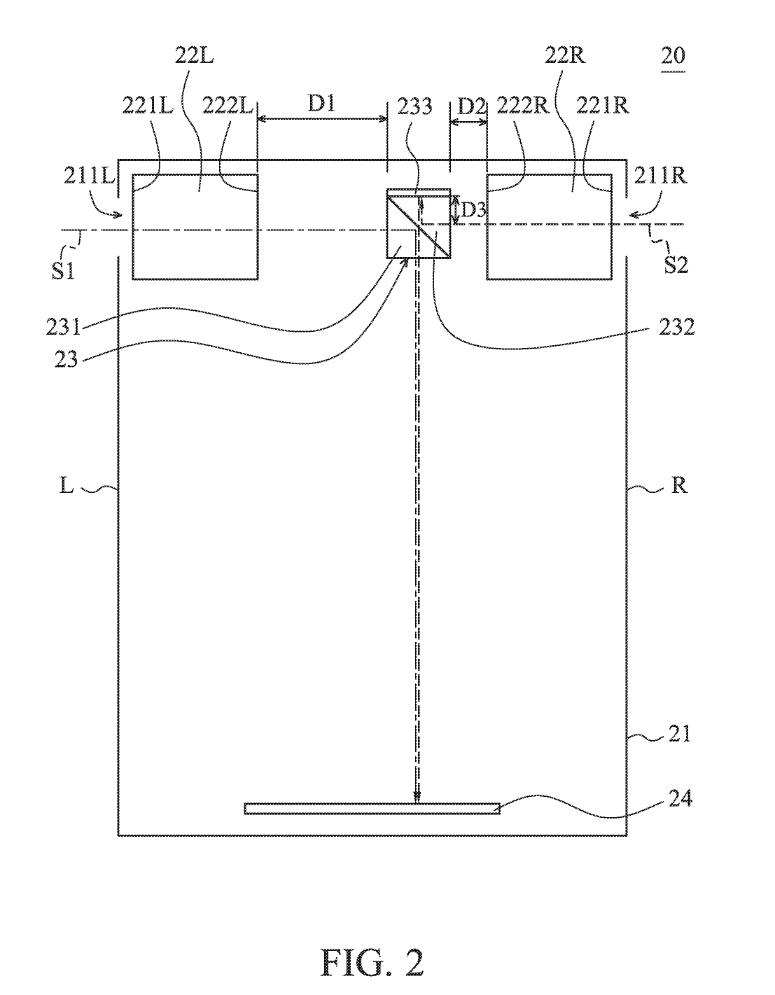

Please refer to FIG. 2. A double direction camera 20 includes a housing 21, two lens assemblies 22L and 22R, a light path conversion member 23 and a light sensor 24. The housing 21 has two openings 211L and 211R, respectively formed at the left side L and right side R. The two lens assemblies 22L and 22R are constituted of a plurality of lenses (not shown in figure), and the two lens assemblies 22L and 22R respectively have a light incident surface 221L (221R) and a light emitting surface 222L (222R), wherein the light incident surfaces 221L (221R) correspond to the one of the openings 221L (221R) of the housing 21 so as to receive a light beam S1 and a light beam S2 from ambient light, and the light emitting surfaces 222L (222R) of the two lens assemblies 22L and 22R face each other.

The light path conversion member 23 is disposed between the two lens assemblies 22L and 22R and includes two prisms 231 and 232 and a reflective mirror 233. The two prisms 231 and 232 are both dispersive prisms, which allow light reflection, light refraction and light transmission. In this embodiment, the bottoms of the two prisms 231 and 232 are connected or bounded together, and the reflective mirror 233 is adjacent to the prism 232.

In one exemplary embodiment, the prism 231 is located at the lower left side of the prism 232, and the reflective mirror 233 is located at the upper side of the prism 232, wherein a distance D3 is formed between the substantial center of the bottom of the prism 232 and the surface of the reflective mirror 233. The prism 231 is spaced from the light emitting surface 222L of the lens assembly 22L by a distance D1, and the prism 232 is spaced from the light emitting surface 222R of the lens assembly 22R by a distance D2.

Due to the arrangement that the lens assemblies 22L and 22R are correspondingly disposed at opposite sides of the light path conversion member 23 and the light emitting surface 222L and 222R face each other, the lens assemblies 22L and 22R and the light path conversion member 23 are disposed along the same straight line, but it should not limited thereto. The light path conversion member 23 of the double direction camera 20 of the invention can be disposed randomly if the light beams from the light emitting surfaces 22L and 22R can be received thereby. Additionally, in the embodiment, a plane is defined at the connecting bottom surfaces of the two prisms 231 and 232, wherein an angle between the plane and the straight line is equal to 45 degrees.

The light sensor 24 corresponds to the light path conversion member 23 disposed on the bottom surface of the housing 21. Specifically, the light sensor 24 faces the reflective mirror 233 of the light path conversion member 23 and receives the light beam or image therefrom. The light sensor 24 is an image sensor, a CCD image sensor or CMOS sensor, used for capturing images and converting it into electrical signals. Since the light sensor 24 is well within the knowledge of one skilled in the art, further elaboration will not presented here regarding the light sensor 24.

The operational principle of the double direction camera 20 is described below. After a first light beam S1 or a second light beam S2 from the openings 211L or 211R of the housing 21 penetrates into the double direction camera 20, it passes the lens assemblies 22L or 22R and is projected onto the light path conversion member 23. In this embodiment, after the first light beam S1 is projected onto the prism 231, a part of the first light beam S1 is directly refracted to the light sensor 24, so that the light sensor 24 captures the first light beam S1 from the prism 231. On the other hand, after the second light beam S2 is projected to the prism 232, a part of the second light beam S2 is refracted into the reflective mirror 233 and then reflected by the reflective mirror 233, and a part of the second light beam S2, reflected by the reflective mirror 233, passes through the prism 232 and prism 231 and is projected onto the light sensor 23 so that the light sensor 24 captures the second light beam S2.

It is noted that in this embodiment, because the traveling distance of the first light beam S1 before being projected onto the light sensor 24 is larger than the traveling distance of the second light beam S2 before being projected onto the light sensor 24 by two times of the distance D3, the energy of the second light beam S2 projected onto the light sensor 24 is less than the energy of the first light beam S1 projected onto the light sensor 24. In this regard, the distances D1 and D2, in one exemplary embodiment, are adjusted for compensation to solve the problem of energy difference. Specifically, by adjusting the position of the light path conversion member 23, the light path conversion member 23 is closer to the light emitting surface 222R. That is, the distance D2 is shortened, so that the traveling distances of the first and second light beam are the same, and the energy of the first light beam 51 and the second light beam S2 projected onto the light sensor 24 are roughly the same. However, while making the compensation, the design of the lens assemblies 22L and 22R should be modified to ensure that the first light beam S1 and the second light beam S2 are still focused on the light sensor 24.

In one exemplary embodiment, to make the compensation, the position of the lens assemblies 22L and 22R can be adjusted, wherein the distances between the lens assemblies 22L and 22R and the openings 211L and 211R are adjusted. In one exemplary embodiment, by utilizing hardware, such as adjusting the image by digital signal processing (DSP), the compensation can be made. Alternatively, by utilizing software, such as by adjusting the image by digital image process technology, the compensation can be made.

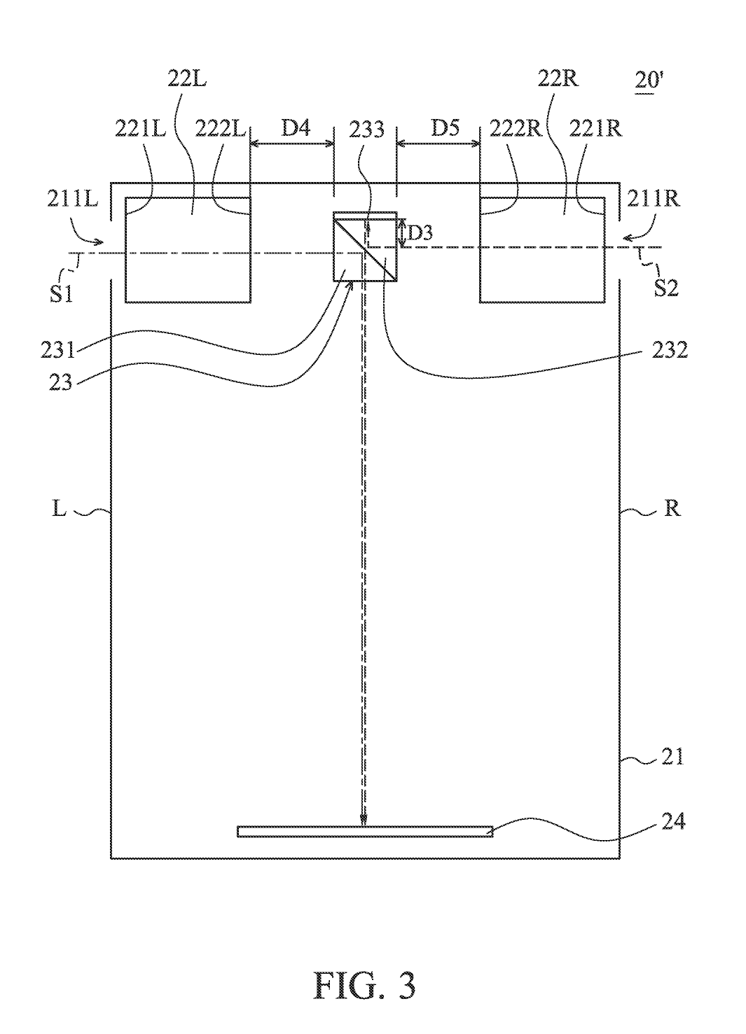

Please refer to FIG. 3. FIG. 3 shows a double direction camera 20′ of a second embodiment of the invention, wherein a prism 231 is spaced from a light emitting surface 222L of a lens assembly 22L by a distance D4, and a prism 232 is spaced from a light emitting surface 222L of a lens assembly 22R by a distance D5, wherein the distance D4 is equal to the distance D5.

Similarly, to solve the problem where the traveling distance of a first light beam S1, before being projected onto the light sensor 24, is different from that of a second light beam S2, before being projected onto the light sensor 24, the focal length of the lens assembly 22R which receives the second light beam S2 is different from the focal length of the lens assembly 22L which receives the first light beam S1. Specifically, the focal length of the lens assembly 22R is larger than the focal length of the lens assembly 22L by two times, distance D3. Thus, the energy that the first light beam S1 and second light beam S2 projects onto the light sensor 24 is roughly the same.

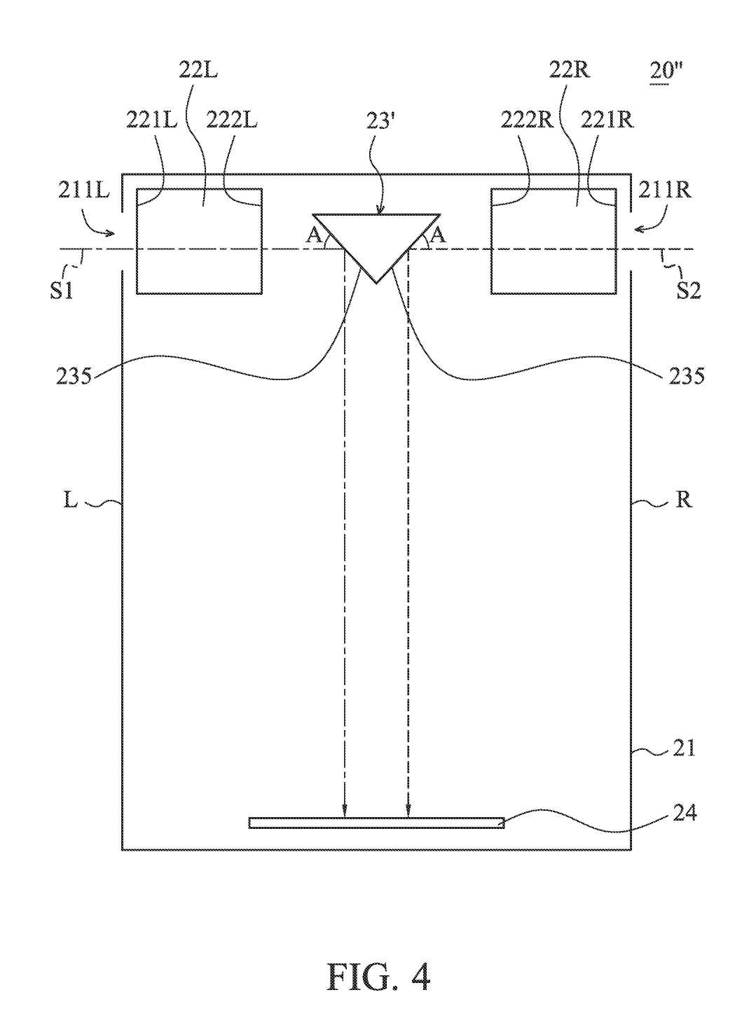

Please refer to FIG. 4. FIG. 4 shows a double direction camera 20″ of a third embodiment of the invention. In the embodiment, the light path conversion member 23′ has a triangular shape and has two lateral mirrors 235, respectively, facing the light emitting surfaces 222L and 222R of the lens assemblies 22L and 22R, wherein the first light beam S1 and the second light beam S2 are projected onto the two lateral mirrors 235 with an incident angle A, so that the first light beam S1 and the second light beam S2 are refracted by the two lateral mirrors 235 to the light sensor 24. In the embodiment, the incident angle A is 45 degrees, but it should not be limited thereto. The incident angle A can be adjusted according to the arrangement of the two lateral mirrors 235.

In the third embodiment, the light path conversion member can be formed by a single prism, two prisms or bounding by two mirrors having reflection property. For example, the above mentioned imaging results can be achieved by projecting the first light beam S1 and the second light beam S2 onto two surfaces 235 of a single prism. Because only one prism is utilized in the embodiment, the cost of the light path conversion member 23′ can be reduced while compared with the other embodiments.

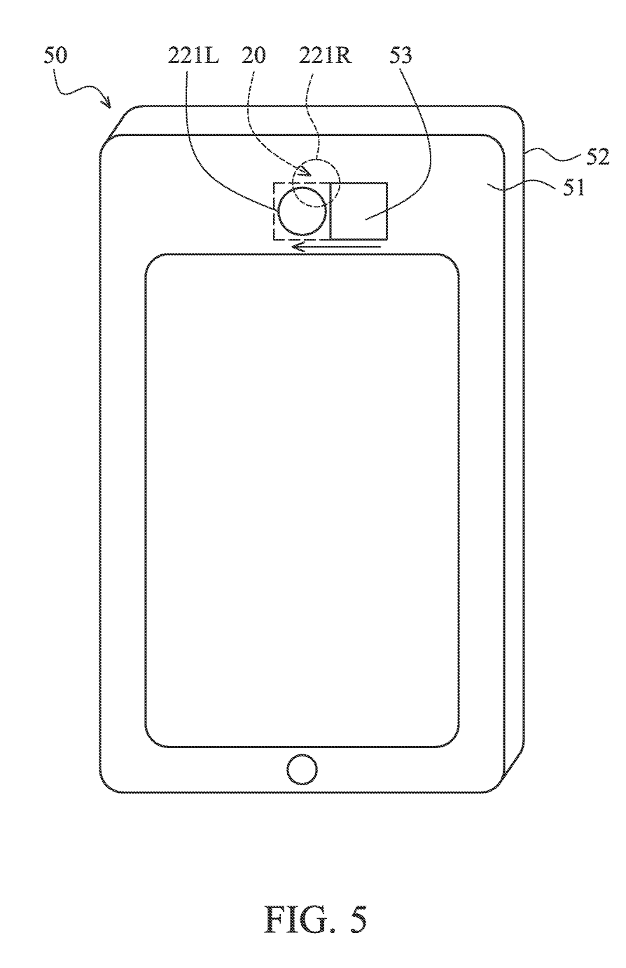

Please refer to FIG. 5. In one exemplary embodiment, the double direction camera can be applied for a portable electronic device 50, such as laptop, tablet or mobile phone. The openings 211L and 211R are respectively formed at a front side 51 and a rear side 52 of the portable electronic device 50 for capturing the first light beam S1 and the second light beam S2.

In one exemplary embodiment, because the number of the light sensor 24 is one, only one of the first light beam S1 or the second light beam S2 can be captured thereby at one time. To determine the selection of the first light beam S1 or the second light beam S2, covers 53 are disposed in front of the openings 221L and 221R, wherein the covers 53 are optionally opened by hand operation. Alternatively, other software or hardware can be used to automatically implement the selection of the first light beam S1 or the second light beam S2. For example, by setting the first light beam has higher priority than the second light beam S2. Thus, once the first light beam S1 and the second light beam S2 simultaneously penetrate onto the light sensor, the signal of the second light beam S2 is omitted.

Through the light path conversion member, the double direction camera of the invention allows images from different directions to be projected onto the same light sensor, whereby the number of the light sensors can be reduced, and the problem of the prior art can be solved. Note that the structural feature of the light path conversion member should not be limited to the above-mentioned embodiment. Any element, which is capable of converging light beams from different lens assemblies into one light sensor, can be applied as the light path conversion member of the invention.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A double direction camera, having a first side and a second side opposite to the first side, wherein the double direction camera comprises:
a light sensor;
a light path conversion member, used for projecting a light beam to the light sensor;
a first lens assembly, disposed on the first side, used for receiving the light beam and projecting the light beam to the light path conversion member; and
a second lens assembly, disposed on the second side, used for receiving the light beam and projecting the light beam to the light path conversion member.

2. The double direction camera as claimed in claim 1, wherein the light path conversion member comprises two lateral mirrors, respectively facing the first lens assembly and the second lens assembly.

3. The double direction camera as claimed in claim 1, wherein the light path conversion member comprises a reflective mirror, a first prism and a second prism, wherein the reflective mirror faces the light sensor, and the first prism and the second prism are disposed between the reflective mirror and the light sensor.

4. The double direction camera as claimed in claim 3, wherein the light beam passing through the first lens assembly is refracted by the first prism and projected to the light sensor, and the light beam passing through the second lens assembly is refracted by the second prism and projected to the reflective mirror and reflected to the light sensor by the reflective mirror.

5. The double direction camera as claimed in claim 4, wherein a first distance and a second distance are respectively defined between the first lens assembly and the light path conversion member and the second lens assembly and the light path conversion member, wherein the second distance is less than the first distance.

6. The double direction camera as claimed in claim 4, wherein a first distance and a second distance are respectively defined between the first lens assembly and the light path conversion member and the second lens assembly and the light path conversion member, wherein the second distance equals to the first distance.

7. The double direction camera as claimed in claim 1, wherein the light path conversion member comprises a prism and the two sides of the prism respectively face the first lens assembly and the second lens assembly.

8. The double direction camera as claimed in claim 1, wherein the first lens assembly, the second lens assembly and the light path conversion member are disposed along the same straight line.

9. A portable electronic device, comprising:
a housing, comprising a front side and a back side opposite to the front side, and comprising:
a first opening, formed at the front side; and
a second opening, formed at the back side; and
a double direction camera as claimed in claim 1, wherein the first lens assembly comprises a first light incident surface, corresponding to the first opening, and the second lens assembly comprises a second light incident surface, corresponding to the second opening.

10. The portable electronic device as claimed in claim 9, wherein the light path conversion member comprises two lateral mirrors, respectively facing the first lens assembly and the second lens assembly.

11. The portable electronic device as claimed in claim 9, wherein the light path conversion member comprises a reflective mirror, a first prism and a second prism, wherein the reflective mirror faces the light sensor, and the first prism and the second prism are disposed between the reflective mirror and the light sensor.

12. The portable electronic device as claimed in claim 9, wherein the housing further comprises two protective covers, respectively corresponding to the first opening and the second opening.
